(19) United States
(12) Patent Application Publication
(10) Pub. No.: US 2007/0065650 A1
(43) Pub. Date: Mar. 22, 2007

(54) Low gauge stretch wrap film

(76) Inventors: John A. Cook, North Canton, OH (US); Brooke Kitzmiller, North Canton, OH (US)

Correspondence Address: MCANDREWS HELD & MALLOY, LTD, 500 WEST MADISON STREET, SUITE 3400, CHICAGO, IL, 60661, US

(21) Appl. No.: 11/593,787

(22) Filed: Nov. 6, 2006

Related U.S. Application Data
(63) Continuation-in-part of application No. 10/092,381, filed on Mar. 4, 2002, now Pat. No. 7,172,815.
(60) Provisional application No. 60/326,834, filed on Oct. 3, 2001.

(51) Int. Cl. B32B 27/32; B32B 27/08

(52) U.S. Cl. 428/220; 428/523; 428/516; 428/522; 428/520

(57) ABSTRACT

Stretch wrap films are used to hold goods to pallets during storage and shipping. Multilayer stretch wrap films are provided herein with at least one outer layer of polypropylene and other layers of blends of polyethylenes. In preferred embodiments, stretch wrap films comprise a cling layer comprising a heterogeneously branched ultra low density polyethylene, a non-cling layer, and at least one core layer comprising linear low density polyethylene and low density polyethylene. Preferred embodiments of films of the present technology optimize physical properties enabling the film to have sufficient cling while creating a tolerable noise level upon unwinding. The optimized properties can include good clarity, high load containment, high puncture resistance, high stretch and good tear resistance.

### RELATED APPLICATIONS

This utility patent application is a continuation-in-part of pending U.S. patent application Ser. No. 10/092,381, filed Mar. 4, 2002, which claims the benefit of U.S. Provisional Patent Application Ser. No. 60/326,834, filed Oct. 3, 2001, now abandoned. For continuity purposes, the disclosures of U.S. patent application Ser. No. 10/092,381 and U.S. Provisional Patent Application Ser. No. 60/326,834 are incorporated by reference herein.

### TECHNICAL FIELD

The present technology generally relates to a multilayer stretch wrap film. More particularly embodiments of stretch wrap films of the present technology comprise a core layer, a cling layer and a non cling layer.

### BACKGROUND OF THE INVENTION

Stretch wrap film is commonly used to wrap a load on a pallet. The film holds goods on a pallet so that the pallet can be stored, shipped and maneuvered. Several physical properties are required for good stretch wrap film. The film should have good stretch, puncture resistance and load containment. The film should also resist tear propagation. The film must have clarity or good optics so that the contents of the pallet can be viewed through the film.

Stretch wrap film may have a non-cling surface and a cling surface opposite the noncling surface. The non-cling surface generally does not cling to itself and prevents adjoining pallets from sticking to one another. The cling surface enables the film to stick to itself. The cling surface should have sufficient cling so that the film sticks to itself when wrapped around a pallet and does not unravel. However, as cling of the film increases, so does the noise the film creates when it is unwound from the roll during the wrapping process. The noise levels created by unwinding some films with polypropylene non-cling layers are too high to be tolerated by individuals working around the pallets without ear protection, due to the need for an aggressive cling agent to stick to the polypropylene. Therefore, a film is needed with sufficient cling that also yields a tolerable noise level.

There is a constant need to decrease the cost of film for wrapping and shipping pallets. Accordingly, what is needed is a film that has comparable or superior load containment, stretch, puncture resistance, and tear resistance to other stretch wrap films but may be used at a lower gauge than commonly used stretch wrap films. The cost of film to wrap the pallet is thereby decreased.

### BRIEF SUMMARY OF THE INVENTION

In at least some embodiments, the present technology provides stretch wrap films with a balanced set of beneficial properties including high puncture resistance, load containment, stretch, tear resistance and clarity.

In at least some embodiments, the present technology provides stretch wrap films with sufficient cling that also create a tolerable noise upon unwrapping.

Films of the present technology may have three or more layers. Preferred films of the present technology have at least three layers: a core layer, a cling layer, and a non-cling layer. Each core layer preferably contains a small percentage of low density polyethylene combined with linear low density polyethylene, a blend that optimizes several properties, including ultimate stretch, on-pallet stretch, load containment, stretch, puncture resistance and tear resistance of the film. The core layer or layers preferably make up about 40% to about 96% of the thickness of the film. In at least one three layer embodiment, the film has a single core layer, a cling layer, and a non cling layer. In at least one five layer embodiment, the film has two additional core layers. In at least one seven layer embodiment, the film has five core layers, a cling layer, and a non-cling layer.

The cling layer may contain a balance of plastomer and ultra-low density polyethylene that optimizes the cling to noise characteristic of the film. The cling layer makes up from about 2% to about 30% of the thickness of the film. In a preferred embodiment the cling layer is about 10% of the overall thickness of the film.

Additional aspects and advantages of this invention will be apparent from the following detailed description of preferred embodiments thereof, which proceeds with reference to the accompanying drawings.

### BRIEF DESCRIPTION OF SEVERAL VIEWS OF THE DRAWINGS

FIG. 1 is a depiction of one embodiment of a film of the present technology having five layers.

FIG. 2 is a depiction of one embodiment of a film of the present technology having three layers.

FIG. 3 is a depiction of one embodiment of a film of the present technology having seven layers.

FIG. 4 is a graph illustrating ultimate stretch and on-pallet stretch for Examples 3-9.

FIG. 5 is a graph illustrating stretch force and containment force for Examples 3-9.

FIG. 6 is a graph illustrating necked-in width, on-pallet puncture energy, and haze at 200% stretch for Examples 3-9.

### DETAILED DESCRIPTION OF THE INVENTION

The present technology relates to stretch films with an optimized balance of beneficial properties. Preferred embodiments of stretch films of the present technology have three or more layers, including a core layer, a cling layer and a non-cling layer. Embodiments of the present films with five or fewer layers can be represented by the construction A/B/C/D/E, such as the construction illustrated in FIG. 1. In such constructions, A is a cling layer, E is a non-cling layer and B, C, and D can be the same or different polymer resins, and are preferably selected to optimize the features discussed above in connection with the core layer, namely load containment, stretch, and puncture resistance while maintaining adequate tear propagation.

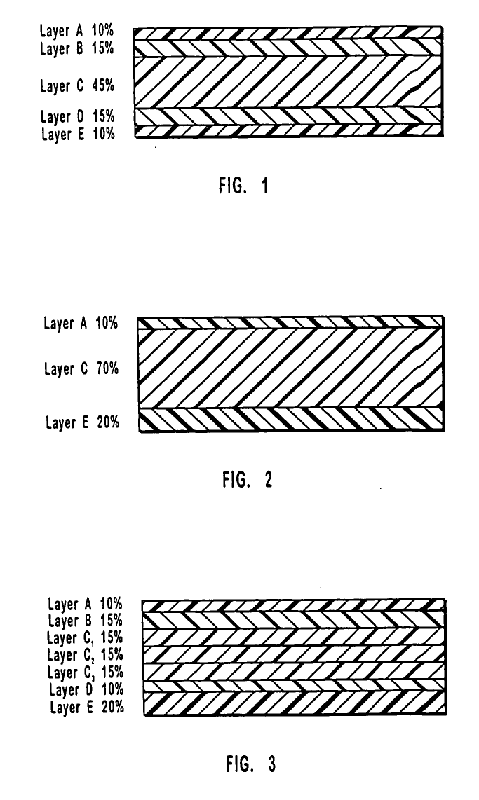

FIG. 2 depicts an embodiment in which the film has three layers, represented by the construction A/C/E. FIG. 3 depicts an embodiment with seven layers, represented by the construction A/B/C₁/C₂/C₃/D/E.

The thicknesses shown in FIGS. 1-3 are exemplary. For example, the film shown in FIG. 1 has the construction A/B/C/D/E with corresponding percentage thicknesses of 10/15/45/10/20 of the total thickness of the film. The construction A/C/E shown in FIG. 2 is depicted with corresponding percentage thicknesses of 10/70/20 of the total thickness of the film. The construction A/B/C₁/C₂/C₃/D/E, as shown in FIG. 3, is shown with corresponding percentage thicknesses of 10/15/15/15/15/10/20 of the total thickness of the film.

Note that various combinations are possible. For example, the film depicted in FIG. 3 can have five identical core layers, B/C₁/C₂/C3/D. Alternatively, for example, the seven layer film depicted in FIG. 3 can have four core layers, B/C₁/C₂/C₃, two adjoining non-cling layers, D/E, and a cling layer A.

Multilayer cast films of the present technology are typically manufactured by feed block coextrusion. Alternatively, the stretch films of the present technology can be made by blown film (tubular) coextrusion. Methods for feed block and blown film extrusion are disclosed, for example, in The Wiley Encyclopedia of Packaging Technology, pp. 233-38 (Aaron L. Brody et al. eds., 2nd Ed. 1997), which is incorporated herein by reference. Some methods for film extrusion are also disclosed in U.S. Pat. No. 6,265,055, which is also incorporated herein by reference.

Cling layers of the present technology should enable a film of the present technology to cling to itself when the film is wrapped on a load. Preferably, the cling layer of a film of the present technology is from about 2% to about 30% of the total thickness of the film, and is more preferably about 10%. Cling layers of the present technology comprise ultra low density polyethylene, and optionally a plastomer. In some preferred embodiments, the cling has a balance of ultra low density polyethylene and plastomer that enables the film to have sufficient cling without creating an intolerable noise level upon unwinding the film.

The cling layer may comprise from about 60% to 100% by weight of the cling layer of an ultra low density polyethylene. Ultra low density polyethylene (hereinafter “ULDPE”) is sometimes also known as very low density polyethylene. ULDPE is ethylene copolymerized with at least one C₃-C₁₀ α-olefin, and is more preferably a C₈ α-olefin. ULDPE suitable for use in the present technology preferably has a density ranging from about 0.885 g/cm³ to about 0.920 g/cm³, more preferably from about 0.888 g/cm³ to about 0.910 g/cm³, and a melt index ranging from 1.0 g/10 min to 20 g/10 min, more preferably ranging from about 2 g/10 min to about 10 g/10 min. In a preferred embodiment, the cling layer contains about 85% by weight of a ULDPE that is ethylene copolymerized with a C₈ α-olefin with a density of about 0.900g/cm³, and a melt index of about 5 g/cm³.

ULDPE can be produced by a variety of processes, including gas phase, solution and slurry polymerization as disclosed in The Wiley Encyclopedia of Packaging Technology pp. 748-50 (Aaron L. Brody et al. eds., 2nd Ed. 1997), referenced above. ULDPE is typically manufactured using a Ziegler-Natta catalyst, although a number of other catalysts may be used. For example, ULDPE may be manufactured with a metallocene catalyst. Alternatively, ULDPE may be manufactured with a catalyst that is a hybrid of a metallocene catalyst and a Ziegler-Natta catalyst. Some methods for manufacturing ULDPE are also disclosed in U.S. Pat. No. 5,399,426, U.S. Pat. No. 4,668,752, U.S. Pat. No. 3,058,963, U.S. Pat. No. 2,905,645, U.S. Pat. No. 2,862,917, U.S. Pat. No. 2,699,457, which are incorporated by reference herein. The density of ULDPE is generally achieved by copolymerizing ethylene with a sufficient amount of one or more monomers. The monomers are preferably selected from 1-butene, 1-hexene, 4-methyl-1-pentene and 1-octene.

In some embodiments, cling layers of the present technology comprise amounts of plastomer from about 1% by weight of the cling layer to about 40% by weight of the cling layer. For example, some embodiments comprise plastomer in an amount from about 0.5%, or from about 1%, by weight to about 15% by weight of the cling layer. For example, a cling layer of the present technology can comprise plastomer in an amount of about 1%, about 2%, about 3%, about 4%, about 5%, about 6%, about 7%, about 8%, about 10%, about 12%, less than about 15%, or about 15% by weight of the cling layer. In at least one embodiment, the cling layer comprises plastomer in an amount from about 1% to about 10% by weight of the cling layer, or from about 1% to about 5% by weight of the cling layer. In other embodiments, cling layers of the present technology comprise plastomer in amounts of at least about 15% by weight of the cling layer, or greater than 15% by weight of the cling layer. For example, a cling layer of the present technology can comprise plastomer in an amount of about 20%, about 25%, about 30%, about 35%, about 40%, or greater than about 40% by weight of the cling layer.

Plastomers suitable for use with the present technology are preferably ethylene copolymerized with a C₃-C₁₀ α-olefin. Preferably, such plastomers have a density in the range from about 0.850 g/cm3 to about 0.900 g/cm³, more preferably of about 0.860 g/cm³ to about 0.880 g/cm³. In some preferred embodiments, plastomers have a melt index of about 1.0 g/10 min to about 20.0 g/10 min, more preferably from about 2.0 to about 10.0 g/10 min. In one embodiment of the present technology, the cling layer contains 15% plastomer with a density of about 0.875 g/cm³ and a melt index of about 3.0 g/10 min. The plastomer can be manufactured by the same process described above with reference to ULDPE, except that a higher amount by weight of one or more monomers is copolymerized with ethylene. In a preferred embodiment, the plastomer is ethylene copolymerized with a C₈ α-olefin, which has an unstretched cling of 250 g and a 200% stretched cling of 66 g as measured by ASTM D 4649. Cling is the strength required, in grams, to pull apart overlapping film along a test section.

In some embodiments, the ULDPE tends to provide the film with limited cling, and the addition of plastomer can provide greater cling in the resulting film. Embodiments of films of the present technology containing percentage weights of ULDPE in the higher ranges specified herein for ULDPE tend to create less noise during unwrapping and have less cling. In contrast, embodiments of films with a higher percentage weight of plastomer tend to provide greater cling but more noise. In preferred embodiments the use of ULDPE and plastomer provide a balanced film, with a sufficient amount of cling and an intermediate noise level.

Embodiments of stretch films of the present technology can have one or more core layers. The core layer, or layers, can be up about 40% to about 96% of the total thickness of the film, more preferably about 70% of the thickness of the film. Each core layer preferably comprises a low density polyethylene and a linear low density polyethylene (hereinafter “LLDPE”).

The amount of LLDPE in the core layer can be from about 94% by weight of the core layer to about 99.9% by weight of the core layer. In some embodiments, the amount of LLDPE is from about 94% by weight of the core layer to about 97% by weight of the core, from about 94% by weight of the core layer to about 95% by weight of the core layer, or from about 97% by weight of the core layer to about 99.9% by weight of the core layer. The amount of LLDPE in the core layer in some embodiments is about 94%, about 95%, about 96%, about 97%, about 98%, about 99%, or about 99.9% by weight of the core layer.

The amount of low density polyethylene in the core layer can be from about 0.01% by weight of the core layer to about 6% by weight of the core layer. For example, in some embodiments, the amount of low density polyethylene in the core layer is from about 0.01% by weight of the core layer to about 3% by weight of the core layer, from about 3% by weight of the core layer to about 6% by weight of the core layer, or from about 5% by weight of the core layer to about 6% by weight of the core layer. In at least one embodiment, the core layer comprises low density polyethylene in an amount less than about 3% by weight of the core layer. In other embodiments, the core layer comprises low density polyethylene in an amount of about 3%, about 4%, about 5%, less than about 6%, or about 6% by weight of the core layer.

The low density polyethylene (LDPE) of the core layer can have a density ranging from about 0.900 g/cm³ to about 0.940 g/cm³, more preferably from about 0.900 g/cm³ to about 0.920 g/cm³, or from about 0.920 g/cm³ to about 0.930 g/cm³. In some embodiments, the LDPE has a melt index ranging from about 0.10 g/10 min to about 10.0 g/10 min, from about 1 g/10 min to about 10.0 g/10 min, or from about from about 2 g/10 min to about 10.0 g/10 min. In some embodiments, the LDPE has a melt index ranging from about 0.2 g/10 min to about 0.4 g/10 min. LDPE is generally used for heavy bags, such as ice bags or shipping sacks, which normally have a thickness from 1.5 mil to 4.0 mil. In contrast, films of the present technology preferably have a thickness of 0.5 mil to 1.5 mil. A mil is a unit of distance equivalent to 0.001 inch (25.4 microns).

LDPE suitable for use with the present technology can be ethylene homopolymer, or ethylene copolymerized with one or more monomers, such as vinyl acetate, butyl acrylate, methyl acrylate, acrylic acid, ethyl acrylate, or a C₃-C₁₀ α-olefin. The LDPE is preferably ethylene homopolymer with a density of about 0.921 g/cm³ and a melt index of about 0.2 g/10 min. An alternative embodiment of the stretch film contains an LDPE that is a copolymer. Methods for manufacturing LDPE are disclosed in The Wiley Encyclopedia of Packaging Technology (Aaron L. Brody et al. eds., 2nd Ed. 1997) pp. 753-754 and in U.S. Pat. No. 5,399,426, both of which are referenced above.

Linear low density polyethylene (LLDPE) is preferably ethylene copolymerized with one or more C₃-C₁₀ α-olefins, with a density ranging from about 0.890 to about 0.940 g/cm³, more preferably from about 0.900 g/cm³ to about 0.930 g/cm³, or from about 0.910 g/cm³ to about 0.930 g/cm³. In preferred embodiments, the LLDPE has a melt index ranging from about 1.0 to about 20.0 g/10 min., more preferably from about 1.0 g/10 min to about 10.0 g/10 min, or from about 1.5 g/10 min to about 6.0 g/10 min. Similar to the ULDPE discussed above, LLDPE used in the films of the present technology is preferably ethylene copolymerized with one monomer of 1-butene, 1-hexene, 4-methyl-1-pentene, or 1-octene. LLDPE may alternatively contain more than one comonomer selected from α-olefins such as 1-butene, 1-hexene, 4-methyl-1 -pentene, and/or 1-octene. In at least one embodiment, the core layer contains about 97% to about 99.9% of LLDPE that is ethylene copolymerized with a C₈ α-olefin, with a density of 0.917 g/cm³ and a melt index of 4.0 g/10 min.

LLDPE is preferably manufactured by the same processes discussed above in connection with ULDPE. For example, ethylene may be copolymerized using various catalysts such as a Ziegler-Natta catalyst or a metallocene catalyst, or a combination of these catalysts. LLDPE has a higher density than ULDPE and plastomer because it is copolymerized with a lower concentration of comonomer than ULDPE or plastomer.

The density ranges and melt indexes as disclosed herein for ULDPE and LLDPE and for plastomer and ULDPE partially overlap. However, these polymers may be further distinguished by crystallinity, measured as melt point. A ULDPE with the same melt index and density of LLDPE will have a lower melt point than LLDPE as disclosed herein. Similarly, a plastomer with the same density and melt index of a ULDPE, will have a lower melt point than ULDPE.

As mentioned above, films of the present technology further comprise a non-cling layer of polypropylene. The polypropylene non-cling layer may have a density ranging from about 0.890 g/cm³ to about 0.910 g/cm³, more preferably from about 0.895 g/cm³ to about 0.905 g/cm³ and a melt flow rate from about 2.0 g/10 min to about 40.0 g/10 min. The polypropylene maybe a homopolymer or may be the product of propylene copolymerization with a comonomer, preferably ethylene. Alternatively, propylene may be copolymerized with another comonomer, such as a C₃-C₁₀ α-olefin. The polypropylene of the present invention is preferably a copolymer of propylene and ethylene, with the ethylene content ranging from greater than 0% to about 10% by weight of the copolymer. For example, the copolymer of propylene and ethylene can have an ethylene content of about 0.5%, about 1%, about 2%, about 3%, about 4%, about 5%, about 6%, about 7%, about 8%, about 9(, or about 10%. More preferably the copolymer of propylene and ethylene can have an ethylene content in an amount ranging from about 1% to about 10%, or from about 2% to about 6% by weight. One preferred embodiment has a propylene copolymerized with ethylene, with the ethylene content ranging from about 2% to about 4% by weight, known as random copolymer polypropylene. The random copolymer of polypropylene may have a density of about 0.905 g/cm³ and a melt flow rate of about 10.0 g/10 min. The method for measuring polypropylene melt flow rate is disclosed in The Wiley Encyclopedia of Packaging Technology (Aaron L. Brody et al. eds., 2nd Ed. 1997) p. 677 and methods for manufacturing polypropylene are disclosed in Kirk-Othmer Concise Encyclopedia of Chemical Technology pp. 1420-21 (Jacqueline I. Kroschwitz et al. eds., 4th Ed. 1999), which is incorporated herein by reference.

The amount of each polymer included films of the present technology are preferably selected to create an optimal balance of several physical properties. For example, some embodiments of stretch films of the present technology can balance increased load and holding containment and stretch with clarity, puncture resistance and resistance to tear propagation. Some embodiments of stretch films of the present technology have a core layer that includes linear low density polyethylene with a small percentage of low density polyethylene. The low density polyethylene in such embodiments can provide good load containment, stretch, and necked-in width. As will be discussed in more detail below in conjunction with examples, the amount of low density polyethylene is preferably a low percentage, in the range of about 0.01% to about 6%, or from about 0.01% to about 3%, because at higher percentages, low density polyethylene can reduce the film's puncture resistance, resistance to tear propagation and/or clarity. Therefore, stretch films of the present technology preferably optimize load containment, stretch, puncture resistance and clarity by incorporating a small percentage of low density polyethylene.

It has been discovered that the benefits that can be obtained from the balance of properties of embodiments of the present technology are found in gauges ranging from about 35 gauge or 40 gauge to about 90 gauge. Even more beneficial are the properties of the film of the present invention at gauges ranging from about 45 gauge or 50 gauge to about 80 gauge. At these gauge ranges, it has been discovered that the film performs better than a known higher gauge film, in terms of load containment, stretch, puncture resistance, clarity and tear propagation resistance. Therefore, films of the present technology preferably have a gauge ranging from about 35 gauge or 40 gauge to about 90 gauge, more preferably from about 45 gauge or about 50 gauge to about 80 gauge. At gauges higher than about 90, the films of the present technology do not perform significantly better in terms of load containment, stretch, puncture resistance, clarity and tear propagation resistance when compared with known films having the same gauge. Note, however, that films of the present technology having gauges higher than about 90 gauge still perform satisfactorily in terms of load containment, stretch, puncture resistance, clarity and tear propagation resistance. Note also that these films of the present technology are designed so that they have sufficient cling while also creating tolerable noise upon unwinding.

It is believed that the enhanced performance of films of the present technology is optimized at these gauges because of the manner in which the films are used. Generally, stretch wrap machines run film at a pre-stretch of 200% to 300%. At this level of pre-stretch, films of the present technology below a gauge of about 90 will provide higher resistance to stretch and become stiffer than films of gauges above about 90. The increased level of stiffness at a pre-stretch of 200% to 300% provides enhanced load containment and puncture resistance for films of the present technology having gauges no greater than about 90 gauge or about 80 gauge.

Because of the beneficial properties of the films of the present technology at low gauges, such as the optimized balance of stretch, load containment, puncture resistance and clarity, films of the present technology may be used at a decreased gauge or thickness over conventional stretch films. Conventionally, stretch films range from about 0.4 mil to about 3 mil. Because of the balanced properties of the films of the present technology, a lower gauge film can be used while achieving superior performance as compared to known films of higher gauges. As a result, the end user can use less weight of the films of the present technology to wrap a pallet than would be required to wrap the same load with a known film. Since less film can be used, a cost advantage can be provided.

The overall thickness of the stretch film can be varied depending on the particular end use for which the film is manufactured. The films of the present technology have a thickness that is generally in the range of typical thickness for stretch wrap films, but can be adjusted to fit the desired end use. However, as discussed above, the beneficial properties of the films of the present technology, such as increased stretch puncture resistance and load containment, may allow the films to be used at a decreased gauge or thickness as compared to conventional stretch films.

In addition to the properties discussed above, preferred embodiments of stretch films of the present technology optimize the amount of cling while minimizing the noise created upon unwinding film. Generally, the noise of the film unwinding increases as the cling of the film increases. In the cling layer, the amount of ultra low density polyethylene, a polymer that provides intermediate cling, is preferably balanced against the amount of plastomer, a lower density polyethylene with high cling. As a result, the film preferably has a cling layer that provides sufficient cling with an acceptable noise level upon unwinding.

### EXAMPLES OF THE PREFERRED EMBODIMENTS

Examples are provided of films of the present technology in order to compare the properties of the composition by varying the content of the layers in the films. Example 1 describes a stretch film composition prepared in accordance with the present technology. Example 2 is a hypothetical example of such a film. Examples 3-9 describe film compositions similar to Example 1, except that the level of LDPE in the core layer is varied from 0% to 6% incrementally by one percentage. Tables 3-9 describe the physical properties of the Examples 3-9 which are graphically presented in FIGS. 3-6. Comparative Examples 1-28 compare a film as described in Example 1 with various commercially available conventional films.

### Example 1

Example 1 is a film containing five layers, as represented by the construction A/B/C/D/E with corresponding percentage thicknesses of 10/15/45/10/20 of the total thickness of the film. The polymers in the film as described in the table below are available from the Dow Chemical Company (hereinafter (“Dow”) in Houston, Tex., except as indicated below. The tradename of each polymer is listed in parenthesis next to its description. The film was formed from the following components:

TABLE A

| | | % of Layer |
|---|---|---|
| Layer | Composition | by Wt. |
| A | Ethylene copolymerized with a C₈ α-olefin, | 85% |
| | with a density of 0.900 g/cm³ and a melt index | |
| | of 5.0 g/10 min. (ULDPE) (61520.09L) | |
| | Ethylene copolymerized with a C₈ α-olefin, | 15% |
| | with a density of 0.875 g/cm³ and a melt index | |
| | of 3.0 g/10 min. (Plastomer) (KC8852) | |
| B, C, D | Ethylene copolymerized with a C₈ α-olefin, | 97% |
| | with a density of 0.917 g/cm³ and a melt index | |
| | of 4.0 g/10 min. (LLDPE) (Elite 5230) | |
| | Ethylene homopolymer with a C₈ α-olefin, | 3% |
| | with a density of g/cm³ and a melt index | |
| | of 0.2 g/10 min. (LDPE) (LDPE132i) | |
| E | Random copolymer polypropylene with a | 100% |
| | density of 0.905 g/cm³ and a melt flow | |
| | rate of 10.0 g/10 min. (13S10A) | |
| | (available from Huntsman Chemical) | |

The film, with a 1.15 mil (29.2 micron) thickness, had the following properties; (a) high puncture resistance, about 180 g/mil, by dart drop impact F-50 (ASTM D1709); (b) good optical quality, less than 3% haze (ASTM D1003); (c) high load containment and strength, 5.9 KPSI in the machine direction and 4.4 KPSI in the cross direction (ASTM D882); (d) good stretch, 540% in the machine direction and 640% in the cross direction (ASTM 13 D882); (e) good tear resistance, 390 g/mil MD, and 690 g/mil CD (ASTM D1922); and (f) sufficient non-cling on the non-cling side of the film, coefficient of friction of 1.8 (ASTM D1894). The film had a cling of about 190 grams unstretched and a cling of about 150 grams at 200% stretch according to ASTM test method D4649. As discussed above, the film of the present invention also has a tolerable noise level while still providing sufficient cling.

### Example 2

In another embodiment, the film has three layers, represented by the construction A/C/E, wherein the layers have a corresponding percentages of thickness of 10/70/20. Such a film is illustrated in FIG. 2. The polymers in the film may be obtained, as specified in Table B below, from Dow in Houston, Tex., ExxonMobil Chemical (“ExxonMobil”) in Houston, Tex. and Equistar Chemical Company (“Equistar”) in Houston, Tex. The film has the following composition:

TABLE B

| | | % of |
|---|---|---|
| | | Layer |
| Layer | COMPOSITION | by Wt. |
| A | Ethylene copolymerized with a C₆ α-olefin, with a | 85% |
| | density of 0.900 g/cm³ and a melt index of 5.0 g/10 min. | |
| | (ULDPE) (Dow, formerly Union Carbide, | |
| | Flexomer 9042) | |
| | Ethylene copolymerized with a C₄ α-olefin with a | 15% |
| | density of 0.873 g/cm³ and a melt index of 4.5 g/10 min. | |
| | (plastomer) (Exxon-Mobil Exact 4049) | |
| C | Ethylene copolymerized with a C₆ α-olefin with a | 97% |
| | density of 0.917 g/cm³ and a melt index of 3.5 g/10 min. | |
| | (LLDPE) (ExxonMobil Exceed 357C32) | |
| | Polyethylene homopolymer with a density of 0.918 g/cm³ | 3% |
| | and a melt index of 0.25 g/10 min. (LDPE) | |
| | (Equistar Petrothene NA 940) | |
| E | Random copolymer polypropylene with a density of | 100% |
| | 0.900 g/cm³ and a melt flow rate of 10.0 g/10 min. | |
| | (Equistar Petrothene PP8310-GO) | |

This film would be expected to have optimized beneficial properties, including good cling but tolerable noise, good tear resistance, high puncture resistance, high load containment and high stretch capabilities. Although Example 1 identifies a five layer film and Example 2 identifies a three layer film, the same compositions identified can be used to make a stretch wrap film which includes one or more core layers, at least one cling layer and at least one non-cling layer. For example, the same compositions may be used to make a seven layer film with five core layers, one cling layer and one non-cling layer.

### Examples 3-9

Seven examples, Examples 3-9, have been tested with varying levels of LDPE. Examples 3-9 contain the same composition as described above in Example 1 with two variations. In Example 3, the core layer contains no LDPE. In each remaining comparative example, the core layer contains a small percentage of LDPE. Example 4 includes a core layer with 1% LDPE; Example 5 includes a core layer with 2% LDPE; Example 6 includes a core layer with 3% LDPE; Example 7 includes a core layer with 4% LDPE; Example 8 includes a core layer with 5% LDPE; and Example 9 includes a core layer with 6% LDPE. In addition, Examples 3-9 each include a skin layer made of a polypropylene resin that is designated Dow DS6D82 instead of the Huntsman 13S10A that is identified in Example 1. Dow DS6D82 is a random copolymer polypropylene resin with a density of 0.9 g/cm³ and a melt flow rate of 7 g/10 min.

These examples were tested for the following seven properties: ultimate stretch, on-pallet stretch, stretch force at 100%, containment force, necked-in width, on-pallet puncture energy (puncture resistance) and haze at 200% stretch. Ultimate stretch is tested by incrementally stretching the film from 0% until the film breaks and measuring the stretch percentage at which the film breaks. Stretch force is tested by measuring the amount of force necessary to stretch the film to a specified percentage, 100% in this case. Ultimate stretch and stretch force represent measurements of the film's elongational properties. Haze was measured by ASTM D1003, a method that includes stretching the film to 200% and testing the haze with a hazemeter.

On-pallet stretch, necked-in width, containment force and puncture energy measurements were all conducted with a Lantech Q300, a turntable stretch wrapper. The results for these comparative examples were obtained by running the Lantech Q300 at 200% prestretch with 16 lbs of secondary force and 9 wraps around a testing cage. On-pallet stretch is measured by marking the roll as it unwinds and then measuring the distance between the marks on the cage. Necked-in width is the measurement of the width of the film on the cage as compared to the original width, which was 20 inches. Containment force is a measurement of the force that 9 wraps of film exert on a load cell bar that is attached to the cage. Puncture energy is measured with a hand force gauge that is punched through the film. The hand force gauge measures the amount of force required to punch through the film.

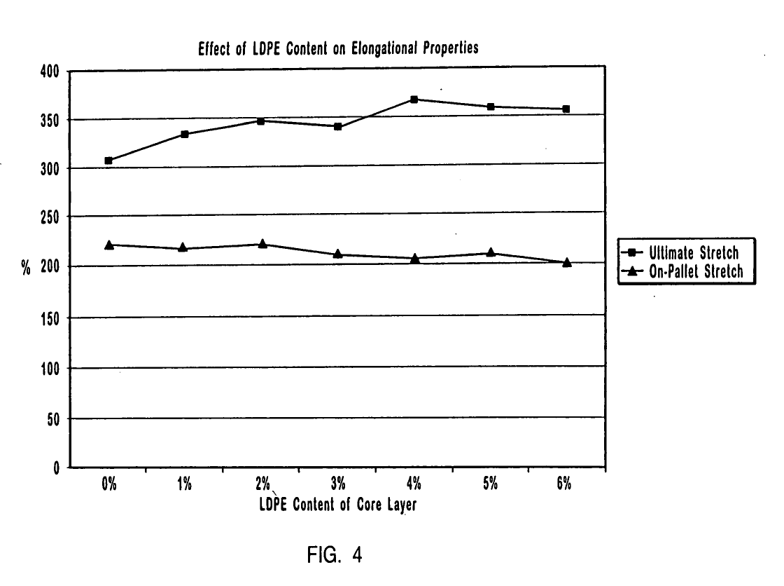

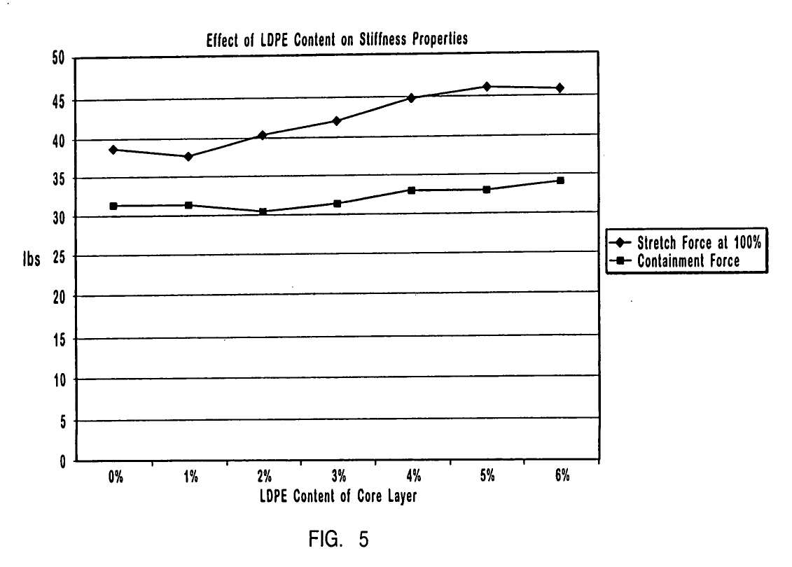

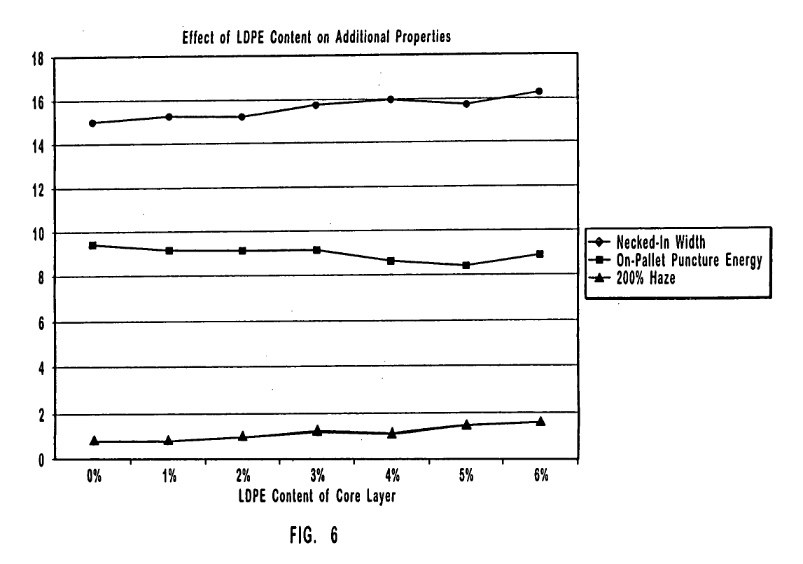

Table C shows the ultimate stretch for each of the six comparative examples. Table D shows the on-pallet stretch for each example. The data contained in these tables is illustrated in FIG. 4. Table E shows the stretch force at 100% for each example and Table F shows the containment force for each example. The data of Tables E and F is illustrated in FIG. 5. Table H shows necked in width, Table I shows on-pallet puncture energy and Table G shows haze at 200% stretch. FIG. 6 illustrates these three properties in graph form.

TABLE C
ULTIMATE STRETCH (%)

| Example | Test 1 | Test 2 | Test 3 | Ave | Std. Deviation |
|---|---|---|---|---|---|
| 3 | 305 | 308 | 308 | 307.00 | 1.73 |
| 4 | 336 | 325 | 339 | 333.33 | 7.37 |
| 5 | 360 | 339 | 341 | 346.67 | 11.59 |
| 6 | 349 | 336 | 335 | 340.00 | 7.81 |
| 7 | 370 | 364 | 363 | 365.67 | 3.79 |
| 8 | 353 | 360 | 361 | 358.00 | 4.36 |
| 9 | 351 | 314 | 359 | 355.00 | 5.66 |

TABLE D
ON PALLET STRETCH

| Example | Stretch % |
|---|---|
| 3 | 222.5 |
| 4 | 217.5 |
| 5 | 222.5 |
| 6 | 212.5 |
| 7 | 207.5 |
| 8 | 212.5 |
| 9 | 202.5 |

TABLE E
STRETCH FORCE AT 100% STRETCH (LBS)

| Example. | Test | Test 2 | Test 3 | Average | Std. Deviation |
|---|---|---|---|---|---|
| 3 | 38 | 38 | 40 | 38.67 | 1.15 |
| 4 | 38 | 38 | 37 | 37.67 | 0.58 |
| 5 | 41 | 40 | 40 | 40.33 | 0.58 |
| 6 | 42 | 42 | 42 | 42.00 | 0 |
| 7 | 44 | 45 | 45 | 44.67 | 0.58 |
| 8 | 45 | 45 | 48 | 46.00 | 1.73 |
| 9 | 46 | 45 | 46 | 45.67 | 0.58 |

TABLE F
CONTAINMENT FORCE

| Example | Force lbs. |
|---|---|
| 3 | 31.5 |
| 4 | 31.5 |
| 5 | 30.5 |
| 6 | 31.5 |
| 7 | 33.0 |
| 8 | 33.0 |
| 9 | 34 |

TABLE G
HAZE AT 200% STRETCH (%)

| | Test | Test | | | Test | | Std. |
|---|---|---|---|---|---|---|---|
| Example | 1 | 2 | Test 3 | Test 4 | 5 | Average | Deviation |
| 3 | 0.75 | 0.79 | 0.79 | 0.79 | 0.84 | 0.79 | 0.031937 |
| 4 | 0.75 | 0.82 | 1.03 | 0.82 | 0.69 | 0.82 | 0.128335 |
| 5 | 0.91 | 1.05 | 1.06 | 1.1 | 0.95 | 1.01 | 0.080187 |
| 6 | 1.29 | 1.22 | 1.23 | 1.29 | 1.26 | 1.26 | 0.032711 |
| 7 | 1.21 | 1.15 | 1.06 | 1.16 | 1.21 | 1.16 | 0.0614 |
| 8 | 1.27 | 1.36 | 1.67 | 1.5 | 1.49 | 1.46 | 0.152217 |
| 9 | 1.32 | 1.62 | 1.63 | 1.9 | 1.59 | 1.61 | 0.205597 |

TABLE H
NECKED-IN WIDTH BASED ON 20 INCH FILM

| Example | Width (inches) |
|---|---|
| 3 | 15.00 |
| 4 | 15.25 |
| 5 | 15.25 |
| 6 | 15.75 |
| 7 | 16.00 |
| 8 | 15.75 |
| 9 | 16.25 |

TABLE I
ON PALLET PUNCTURE ENERGY

| Example | Lbs. |
|---|---|
| 3 | 9.50 |
| 4 | 9.25 |
| 5 | 9.25 |
| 6 | 9.25 |
| 7 | 8.75 |
| 8 | 8.50 |
| 9 | 9.00 |

As can be seen by Tables C, E and F and FIGS. 4-5, ultimate stretch, stretch force and containment force rise as the level of LDPE in the core layer reaches 4%. However, as can be seen in Tables G and I and FIG. 6, haze increases and on-pallet puncture energy decreases as the level of LDPE in the core layer is increased above 3%. At a level of about 3% or less LDPE in the core layer, the film has good stretch, strength and necked-in width while having optimal clarity and puncture resistance. Therefore, levels of LDPE in the core layer at about 3% or less provide an optimal balance of the beneficial properties provided by LDPE.

### Comparative Examples 1-28

Testing for the following examples was performed with a variety of different equipment in various states of repair and at a variety of settings, with various operating personnel at various customer facilities. In all cases, the tests were performed at a customer's facilities that used only the competitor's film. Some of the tests were performed with Lantech 19 equipment, some with Orion equipment and others with Signode equipment. Each of the examples discussed below compares a commercially prepared film of the composition detailed in Example 1 (referred to hereafter as “Sample Film”) to a film of the prior art. However, since the testing was conducted on different equipment, films prepared from the composition in Example 1 having the same gauge produced different results. Gauge is a measure of thickness equivalent to 0.01 mil.

The test results below illustrate the optimization of film properties, particularly at gauges less than about 80 gauge. Despite the varied conditions under which the tests were conducted, the sample films consistently performed nearly as well or better than competitor's films of higher gauges. Thus, it can be seen that low gauges of the inventive film can be used for the same applications as higher gauge films of the prior art. Even though in some of the tests described below, the sample films had a slightly lower containment force weight than the higher gauge prior art film the benefit of using the lower gauge film of the present invention out weighs any slight loss of containment force.

### Comparative Example 1

A Sample Film was prepared for comparison with a film manufactured by AEP under the tradename A12090. The AEP film was a 90 gauge film while the film of Example 1 was a 63 gauge film. It was determined that the AEP film had a film weight/load of 9.9 ounces and the Example 1 film had a film weight/load of 4.9 ounces. The AEP film had a containment force of 23 lbs compared with 28 lbs for the film of Example 1.

### Comparative Example 2

A Sample Film was prepared for comparison with a film manufactured by AEP under the tradename A12090. The AEP film was a 90 gauge film while the Sample Film was a 51 gauge film. It was determined that the AEP film had a film weight/load of 12.9 ounces and the Sample Film had a film weight/load of 5.2 ounces. Containment force was not measured for this comparative example.

### Comparative Example 3

A Sample Film was prepared for comparison with a film manufactured by Tyco/Armin. The Tyco/Armin film was a 70 gauge film while the Sample Film was a 51 gauge film. It was determined that the Tyco/Armin film had a film weight/load of 3.1 ounces and the Sample Film had a film weight/load of 1.7 ounces. The Tyco/Armin film had a containment force of 23 lbs compared with 25 lbs for the Sample Film.

### Comparative Example 4

Two Sample Films were prepared for comparison with a film manufactured by Atlantis under the tradename Linear ADU26720. The Atlantis film was a 105 gauge film while the first Sample Film was a 71 gauge film and the second Sample Film was a 105 gauge. It was determined that the Atlantis film had a film weight/load of 14.4 ounces. The 71 gauge Sample Film had a film weight/load of 9.8 ounces and the 105 gauge Sample Film had a film weight/load of 14.4 ounces. The Line Atlantis film had a containment force of 51 lbs compared with 46 lbs for the 71 gauge Sample Film and 45 lbs for the 105 gauge Sample Film.

### Comparative Example 5

A Sample Film was prepared for comparison with a film manufactured by AEP. The AEP film was an 80 gauge film while the Sample Film was a 51 gauge film. It was determined that the AEP film had a film weight/load of 5.3 ounces and the Sample Film had a film weight/load of 3.3 ounces. The AEP film had a containment force of 23.5 lbs compared with 27 lbs for the Sample Film.

### Comparative Example 6

A Sample Film was prepared for comparison with a film manufactured by Tyco under the tradename AMP2. The Tyco film was a 70 gauge film while the Sample Film was a 51 gauge film. It was determined that the Tyco film had a film weight/load of 8.3 ounces and the Sample Film had a film weight/load of 4.9 ounces. The Tyco film had a containment force of 26 lbs compared with 26 lbs for the Sample Film.

### Comparative Example 7

A Sample Film was prepared for comparison with a film manufactured by Atlantis under the tradename Linear ADC 17820V. The Atlantis film was a 70 gauge film while the Sample Film was a 51 gauge film. It was determined that the Atlantis film had a film weight/load of 6.4 ounces and the Sample Film had a film weight/load of 4.5 ounces. The Atlantis film had a containment force of 25 lbs compared with 25 lbs for the Sample Film.

### Comparative Example 8

A Sample Film was prepared for comparison with a film manufactured by Amtopp. The Amtopp film was an 80 gauge film while the Sample Film was a 51 gauge film. It was determined that the Amtopp film had a film weight/load of 5.3 ounces and the Sample Film had a film weight/load of 3.3 ounces. The Amtopp film had a containment force of 20.5 lbs compared with 27 lbs for the Sample Film.

### Comparative Example 9

A Sample Film was prepared for comparison with a film manufactured by Sigma. The Sigma film was a 100 gauge film while the Sample Film was a 71 gauge film. It was determined that the Sigma film had a film weight/load of 5.1 ounces and the Sample Film had a film weight/load of 3.1 ounces. The Sigma film had a containment force of 48.5 lbs compared with 47.5 lbs for the Sample Film.

### Comparative Example 10

A Sample Film was prepared for comparison with a film manufactured by AEP under the tradename TLC. The AEP film was an 80 gauge film while the Sample Film was a 51 gauge film. It was determined that the AEP film had a film weight/load of 5.5 ounces and the Sample Film had a film weight/load of 2.8 ounces. The AEP film had a containment force of 21.5 lbs compared with 23.0 lbs for the Sample Film.

### Comparative Example 11

A Sample Film was prepared for comparison with a film manufactured by Linear under the tradename ADC8030V. The Linear film was an 80 gauge film while the Sample Film was a 63 gauge film. It was determined that the Linear film had a film weight/load of 28.7 ounces and the Sample Film had a film weight/load of 11.5 ounces. The Linear film had a containment force of 36 lbs compared with 43 lbs for the Sample Film.

### Comparative Example 12

A Sample Film was prepared for comparison with a film manufactured by Paragon. The Paragon film was a 75 gauge film while the Sample Film was a 51 gauge film. It was determined that the Paragon film had a film weight/load of 7.7 ounces and the Sample Film had a film weight/load of 5.3 ounces. The Paragon film had a containment force of 17 lbs compared with 21 lbs for the Sample Film.

### Comparative Example 13

A Sample Film was prepared for comparison with a film manufactured by AEP under the tradename PP1 8020. The AEP film was an 80 gauge film while the Sample Film was a 51 gauge film. It was determined that the AEP film had a film weight/load of 17.6 ounces and the Sample Film had a film weight/load of 8.3 ounces. The AEP film had a containment force of 19 lbs compared with 22 lbs for the Sample Film.

### Comparative Example 14

A Sample Film was prepared for comparison with a film manufactured by Tyco. The Tyco film was a 70 gauge film while the Sample Film was a 51 gauge film. It was determined that the Tyco film had a film weight/load of 4.0 ounces and the Sample Film had a film weight/load of 2.6 ounces. The Tyco film had a containment force of 26 lbs compared with 28 lbs for the Sample Film.

### Comparative Example 15

A Sample Film was prepared for comparison with a film manufactured by Tyco under the tradename MP2. The Tyco film was a 70 gauge film while the Sample Film was a 51 gauge film. It was determined that the Tyco film had a film weight/load of 7.6 ounces and the Sample Film had a film weight/load of 4.0 ounces. The Tyco film had a containment force of 16 lbs compared with 17 lbs for the Sample Film.

### Comparative Example 16

A Sample Film was prepared for comparison with a film manufactured by Tyco. The Tyco film was an 80 gauge film while the Sample Film was a 51 gauge film. It was determined that the Tyco film had a film weight/load of 4.8 ounces and the Sample Film had a film weight/load of 2.9 ounces. The Tyco film had a containment force of 37 lbs compared with 34.5 lbs for the Sample Film.

### Comparative Example 17

A Sample Film was prepared for comparison with a film manufactured by AEP under the tradename Al. The AEP film was a 75 gauge film while the Sample Film was a 51 gauge film. It was determined that the AEP film had a film weight/load of 2.4 ounces and the Sample Film had a film weight/load of 1.5 ounces. The AEP film had a containment force of 26 lbs compared with 28 lbs for the Sample Film.

### Comparative Example 18

Two Sample Films were prepared for comparison with a film manufactured by Tyco. The Tyco film was an 80 gauge film while the first Sample Film was a 51 gauge film and the second Sample Film was a 63 gauge film. It was determined that the Tyco film had a film weight/load of 8.5 ounces. The 51 gauge Sample Film had a film weight/load of 4.1 ounces and the 63 gauge Sample Film had a film weight/load of 5.6 ounces.

### Comparative Example 19

A Sample Film was prepared for comparison with a film manufactured by Atlantis under the tradename Linear ADC-7020. The Atlantis film was a 70 gauge film while the Sample Film was a 51 gauge film. It was determined that the Atlantis film had a film weight/load of 5.06 ounces and the Sample Film had a film weight/load of 3.6 ounces. The Atlantis film had a containment force of 19 lbs compared with 16 lbs for the Sample Film.

### Comparative Example 20

A Sample Film was prepared for comparison with a film manufactured by Linear under the tradename ADC-7020. The Linear film was an 80 gauge film while the Sample Film was a 51 gauge film. It was determined that the Linear film had a film weight/load of 7.9 ounces and the Sample Film had a film weight/load of 4.8 ounces. The Linear film had a containment force of 15 lbs compared with 22 lbs for the Sample Film.

### Comparative Example 21

Two Sample Films were prepared for comparison with a film manufactured by Tyco under the tradename QM1 2010. The Tyco film was a 100 gauge film while the first Sample Film was an 80 gauge film and the second Sample Film was a 71 gauge film. It was determined that the Tyco film had a film weight/load of 7.7 ounces. The 80 gauge Sample Film had a film weight/load of 5.4 ounces and the 71 gauge Sample Film had a film weight/load of 5.0 ounces. The Tyco film had a containment force of 38 lbs compared with 36 lbs for the 80 gauge Sample Film and 42 lbs for the 71 gauge Sample Film. The higher containment force of the 71 gauge Sample Film over the 80 gauge Sample Film illustrates the optimization of beneficial properties that occurs in films of the present invention at gauge ranges of less than 80 gauge.

### Comparative Example 22

A Sample Film was prepared for comparison with a film manufactured by Sigma under the tradename Select Cast. The Sigma film was an 80 gauge film while the Sample Film was a 63 gauge film. It was determined that the Sigma film had a film weight/load of 4.8 ounces and the Sample Film had a film weight/load of 4.1 ounces. The Sigma film had a containment force of 17 lbs compared with 22 lbs for the Sample Film.

### Comparative Example 23

A Sample Film was prepared for comparison with a film manufactured by Paragon. The Paragon film was a 70 gauge film while the Sample Film was a 51 gauge film. It was determined that the Paragon film had a film weight/load of 6.2 ounces and the Sample Film had a film weight/load of 4.9 ounces. The Paragon film had a containment force of 33 lbs compared with 35 lbs for the Sample Film.

### Comparative Example 24

A Sample Film was prepared for comparison with a film manufactured by Tyco under the tradename MP2. The Tyco film was a 100 gauge film while the Sample Film was a 71 gauge film. It was determined that the Tyco film had a film weight/load of 11.6 ounces and the Sample Film had a film weight/load of 8.1 ounces. Containment force was not measured for this comparative example.

### Comparative Example 25

A Sample Film was prepared for comparison with a film manufactured by AEP under the tradename TLC. The AEP film was a 70 gauge film while the Sample Film was a 51 gauge film. It was determined that the AEP film had a film weight/load of 8.7 ounces and the Sample Film had a film weight/load of 5.5 ounces. The AEP film had a containment force of 25 lbs compared with 35 lbs for the Sample Film.

### Comparative Example 26

Two Sample Films were prepared for comparison with a film manufactured by Paragon under the tradename G2.07520N.50. The Paragon film was a 75 gauge film while the first Sample Film was a 63 gauge film and the second Sample Film was a 51 gauge film. It was determined that the Paragon film had a film weight/load of 17.5 ounces. The 63 gauge Sample Film had a film weight/load of 14.5 ounces and the 51 gauge Sample Film had a film weight/load of 9.0 ounces. The Paragon film had a containment force of 35 lbs compared with 55 lbs for the 63 gauge Sample Film and 50 lbs for the 51 gauge Sample Film.

### Comparative Example 27

A Sample Film was prepared for comparison with a film manufactured by Tyco under the tradename Max I. The Tyco film was an 80 gauge film while the Sample Film was a 63 gauge film. It was determined that the Tyco film had a film weight/load of 5.2 ounces and the Sample Film had a film weight/load of 4.2 ounces. The Tyco film had a containment force of 22 lbs compared with 24 lbs for the Sample Film.

### Comparative Example 28

A Sample Film was prepared for comparison with a film manufactured by AEP. The AEP film was an 80 gauge film while the Sample Film was a 51 gauge film. It was determined that the AEP film had a film weight/load of 4.4 ounces and the Sample Film had a film weight/load of 3.0 ounces. The AEP film had a containment force of 12 lbs compared with 12 lbs for the Sample Film.

The invention has been described above in such full, clear, concise and exact terms as to enable any person skilled in the art to which it pertains, to practice the same. It is to be understood that the foregoing describes preferred embodiments of the invention and that modifications may be made thereto without departing from the scope of the invention as set forth in the following claims.

What is claimed is:

1. A multilayer stretch film comprising:
a cling layer comprising a heterogeneously branched ultra low density polyethylene and optionally a plastomer;
a non-cling layer comprising a copolymer of propylene and ethylene wherein said copolymer has an ethylene content of about 1% by weight to about 10% by weight; and
at least one core layer comprising from about 94% by weight of the core layer to about 99.9% by weight of the core layer linear low density polyethylene having a density ranging from about 0.890 g/cm³ to about 0.940 g/cm³ and a melt index of about 1.0 g/10 min to about 10.0 g/10 min, and from about 0.01% to about 6.0% by weight of the core layer low density polyethylene; and
wherein the stretch film has a gauge that is no greater than about 90 gauge.

2. The multilayer stretch film of claim 1, wherein the stretch film has a gauge that is from about 35 gauge to about 90 gauge.

3. The multilayer stretch film of claim 2, wherein the stretch film has a gauge that ranges from about 50 gauge to about 80 gauge.

4. The multilayer stretch film of claim 1, wherein the linear low density polyethylene is an ethylene copolymerized with a C₃-C₁₀ α-olefin.

5. The multilayer stretch film of claim 1, wherein the low density polyethylene is an ethylene homopolymer.

6. The multilayer stretch film of claim 1, wherein the low density polyethylene is an ethylene copolymer.

7. The multilayer stretch film of claim 1, wherein the low density polyethylene is an ethylene copolymerized with at least one selected from the group consisting of vinyl acetate, methyl acrylate, ethyl acrylate, acrylic acid and mixtures thereof.

8. The multilayer stretch film of claim 1, wherein the low density polyethylene has a density of about 0.900 g/cm³ to about 0.940 g/cm³ and a melt index of 0.1 g/10 min to about 10.0 g/10 min.

9. The multilayer stretch film of claim 1, wherein said ultra low density polyethylene is an ethylene copolymerized with a C₃-C₁₀ α-olefin and said ultra low density polyethylene has a density from about 0.850 g/cm³ to 0.900 g/cm³ and a melt index of 1.0 g/10 min to 20.0 g/10 min.

10. The multilayer stretch film of claim 1, having plastomer in an amount from about 1% to about 15% by weight of the cling layer.

11. The multilayer stretch film of claim 1, wherein the at least one core layer comprises from about 97% by weight of the core layer to about 99.9% by weight of the core layer linear low density polyethylene having a density ranging from about 0.900 g/cm³ to about 0.940 g/cm³ and a melt index of about 1.0 g/10 min to about 10.0 g/10 min, and from about 0.01% to about 3.0% by weight of the core layer low density polyethylene.

12. A multilayer stretch wrap film comprising:
at least one first layer comprising a heterogeneously branched ultra low density polyethylene and optionally from about 1% by weight to about 40% by weight of a plastomer;
at least one second layer comprising a polypropylene;
at least one third layer comprising a mixture of from about 94% by weight to about 99.9% by weight linear low density polyethylene having a density ranging from about 0.890 g/cm³ to about 0.940 g/cm³ and a melt index of about 1.0 g/10 min to about 10.0 g/10 min, and from about 0.01% to about 6.0% by weight low density polyethylene having a density of about 0.900 g/cm³ to about 0.940 g/cm³ and a melt index of 0.1 g/10 min to about 10.0 g/10 min;
wherein said third layer is disposed between said first layer and said second layer.

13. The multilayer stretch film of claim 12, wherein the stretch film has a gauge from about 35 gauge to about 90 gauge.

14. The multilayer stretch film of claim 13, wherein the stretch film has a gauge from about 50 gauge to about 80 gauge.

15. The multilayer stretch film of claim 12, wherein the linear low density polyethylene is an ethylene copolymerized with a C₃-C₁₀ α-olefin.

16. The multilayer stretch film of claim 12, wherein the low density polyethylene is an ethylene homopolymer.

17. The multilayer stretch film of claim 12, wherein the low density polyethylene is an ethylene copolymer.

18. The multilayer stretch film of claim 12, wherein the low density polyethylene is an ethylene copolymerized with at least one selected from the group consisting of vinyl acetate, methyl acrylate, ethyl acrylate, acrylic acid and mixtures thereof.

19. The multilayer stretch film as claimed in claim 12, wherein the ultra low density polyethylene is an ethylene copolymerized with a C₃-C₁₀ α-olefin and said ultra low density polyethylene has a density from about 0.850 g/cm³ to 0.900 g/cm³ and a melt index of 1.0 g/10 min to 20.0 g/10 min.

20. The multilayer stretch film as claimed in claim 12, wherein third layer comprises a mixture of from about 97% by weight to about 99.9% by weight linear low density polyethylene having a density ranging from about 0.900 g/cm³ to about 0.940 g/cm³ and a melt index of about 1.0 g/10 min to about 10.0 g/10 min, and from about 0.01% to about 3.0% by weight low density polyethylene having a density of about 0.900 g/cm³ to about 0.940 g/cm³ and a melt index of 0.1 g/10 min to about 10.0 g/10 min.
